(19) United States
(12) Patent Application Publication
(10) Pub. No.: US 2010/0145717 A1
(43) Pub. Date: Jun. 10, 2010

(54) METHOD AND DEVICE FOR REPLACING ACCUMULATORS FOR ELECTRIC VEHICLES AND ELECTRIC VEHICLE

(76) Inventor: Thomas Hoeltzel, Munchen (DE)

Correspondence Address: BLACK LOWE & GRAHAM, PLLC, 701 FIFTH AVENUE, SUITE 4800, SEATTLE, WA, 98104, US

(21) Appl. No.: 12/596,639

(22) PCT Filed: Apr. 18, 2008
(86) PCT No.: PCT/EP2008/054724

§ 371 Date: Feb. 19, 2010

(30) Foreign Application Priority Data
Apr. 19, 2007 (DE) 10 2007 018 874.0
May 25, 2007 (DE) 10 2007 024 718.6
Jul. 11, 2007 (DE) 10 2007 032 210.2

(51) Int. Cl. G06Q 50/00; H02J 7/00; G06Q 90/00; G06F 7/00; B60S 5/06

(52) U.S. Cl. 705/1.1; 320/109; 705/500; 701/33; 180/65.29

(57) ABSTRACT

The invention concerns a method for exchange of accumulators/batteries for electric vehicles, wherein a multiplicity of accumulators/batteries, which are standardised in their construction at least in groups and in at least partly empty energy state, are automatically detached and removed from the electric vehicle from below in a prespecified sequence by means of a fast fixing device, the accumulators/batteries are automatically exchanged for accumulators/batteries in full energy state in a accumulator/battery exchange station and the accumulators/batteries in full energy state are automatically fitted in the electric vehicle in a predeterminable order by means of the fast fixing device.

The invention concerns a method and a device for the exchange of accumulators/batteries for electric vehicles in which in particular energy storage units such as accumulators/batteries for electrically operated vehicles, in particular motor vehicles, are exchanged, wherein the energy storage units are preferably standardised in design for rapid exchange.

Electrically operated motor vehicles frequently have the disadvantage that to recharge their energy storage units such as batteries, very long charge times are required, during which it is not possible to use the electrically powered vehicle. Also such vehicles have a limited range as the actual charging process usually takes place almost exclusively at the vehicle parking place, which can be a garage at home, and the network of electrical charging stations available during travel is only very inadequate.

For example electrically powered vehicles are known such as the so-called Tessla Roadster which indeed has a range of up to 400 km and a top speed of over 210 km/h with an acceleration from 0 to 100 km/h in four seconds, but also requires a charge time of at least 3.5 hours to recharge a discharged accumulator/battery which is permanently installed in the vehicle. Such electric vehicles are competitive with conventional vehicles with combustion engines, but on any journey exceeding a distance of around 400 km, even if a charging station is present, must be parked at one point for a charging time of at least 3.5 hours.

Conventional electrically powered vehicles however have the decisive advantage that in comparison with conventional vehicles with combustion engines, in relation to the energy content of petrol for example they consume only 1.74 litres per 100 km travel and generate no CO2 emissions.

Such accumulators/batteries can also be removed from the vehicle and refitted in these to allow an exchange by a repairing workshop. For this preferably simplified plug couplings are used for the electrical connection between the vehicle motor and vehicle electrics and a battery, as described in DE 94 12 219 U1. This is also the object of CA 2,278,417.

Also such electrically powered vehicles have high procurement costs, amongst others because of the high production costs of such accumulators/batteries fitted in the vehicle. These cost-intensive batteries also usually have a shorter life which, because of the very restricted network of charging stations for vehicle accumulators/batteries available, makes charging necessary not at a convenient time according to the momentary charge state of the battery, but after return of the vehicle to its original location at which normally such a charging station is present. This can lead to a limited life of the previous accumulators/batteries of around 500-1000 charge cycles. It is then necessary to purchase a new battery which is associated with substantial additional costs.

Such cost-intensive accumulators/batteries usually also have a very cost-intensive main charge control unit which is usually integrated inside the electric vehicle.

To allow the exchange of accumulators/batteries with expired life, JP 0 518 400 8 A for example shows a battery change device which is designed to simplify the changing of accumulators/batteries. Frequently here battery transport devices to the accumulator/battery receiving points within the vehicle are provided. An automated roller system is shown which serves to transport the accumulators/batteries to and from the vehicle.

DE 196 41 254 C2 discloses an exchange device for energy supply units of road vehicles which, in the rear area of a goods vehicle, allows an exchange of a accumulator/battery by a level change in the vehicle chassis in the height direction in relation to a charging station. This simplifies the removal of the old battery.

Alternatively G 88 11 058 proposes the fitting of a drive device together with a accumulator/battery on a trailer which is towed by the vehicle, in order thus to simplify the exchange of trailer and hence accumulator/battery. Such a vehicle with separate trailer is difficult to control and has undesirable total vehicle length. Also a separate trailer requires further cost-intensive components, such as for example separate tyres and separate suspension, and has a higher total weight.

EP 0 869 887 B1 discloses a device for preparation for leasing of a multiplicity of electric vehicles including exchange and charging of the vehicle accumulators/batteries, wherein the object of this publication refers as priority to autoscooters. The accumulators/batteries are supplied to the autoscooter here by means of container.

DE 23 60 795 shows an accumulator battery in a specific design, wherein several plates of the accumulator battery are fitted with upward extending contact tabs.

DE 195 27 216 A1 generally discloses a worldwide network of accumulator/battery management stations which is designed to handle all tasks and functions required for provision of electrical energy such as for example the procurement of replacement accumulators/batteries and their charging. This publication does not give a detailed description of how such a network is implemented. The energy for such a station is provided by means of solar systems. The removal of a battery and the insertion of a replacement accumulator/battery are indeed mentioned, but no details are given here.

DE 42 29 687 A1 indeed shows a accumulator/battery change station for electrically powered motor vehicles which is able to remove accumulators/batteries from a vehicle and then reinstall them. This is described in more detail in relation to a single vehicle for the removal of individual empty accumulators/batteries and the installation of full accumulators/batteries. The coordination of several removed accumulators/batteries, their charging, storage and installation, are not described in detail. The accumulator/battery is removed from the vehicle by means of a handling device and exchanged for a accumulator/battery in fully charged state. However no standardised construction of the batteries or complementarily designed recesses within the vehicle are mentioned.

Consequently it is an object of the present invention to provide a method and a device for exchange of accumulators/batteries for electric vehicles which allow rapid and cheap removal of empty accumulators/batteries and the installation of several full accumulators/batteries in the presence of a larger number of accumulators/batteries. An electric vehicle is shown.

This is achieved in relation to the method by the features of claim 1, and in relation to the device by the features of claim 8, and in relation to the vehicle by the features of claim 10.

In the method according to the invention for the exchange of accumulators/batteries for electric vehicles, a multiplicity of batteries which are standardised in construction at least in groups and in at least partly empty energy state, is detached and removed preferably fully automatically from the electric vehicle, preferably from below, in a prespecified order, by means of a fast fixing device, the accumulators/batteries are exchanged automatically for accumulators/batteries of full energy state in a accumulators/battery exchange station and then the accumulators/batteries in full energy state are automatically installed in the electric vehicle in a predeterminable order by means of the fast fixing devices. Both the predeterminable order of the accumulators/batteries to be installed and the prespecified order of the accumulators/batteries removed can be determined and selected, wherein according to a preferred embodiment the predeterminable order of accumulators/batteries to be installed corresponds to the prespecified order of accumulators/batteries removed. The accumulators/batteries can be standardised with regard to the current intensity to be applied. They are fitted with a data unit such as for example an RFID chip which allows allocation of the accumulator/battery to a manufacturer and/or owner of the accumulator/battery and can supply data on the charge cycles applied, the old charge state and other relevant data.

Each battery can send, by means of the data unit attached, further data such as for example the number of charge cycles performed, their time, the services previously performed and the services to be performed, and its momentary location, to a accumulator/battery owner such as for example a accumulator/battery retail company at any location. Evidently such data can also be queried by the accumulator/battery owner concerned at any time and at any place, wherein optionally restricted query rights can be set up with regard to data.

According to a further embodiment, the predeterminable order of the accumulators/batteries to be installed or used by the station can be selected manually or automatically, independently of the prespecified order of the accumulators/batteries removed, by means of selection devices in the vehicles, in the accumulator/battery exchange station and/or in the accumulators/batteries. Such a method allows the construction of an effective working operating network of individual battery exchange stations which not only allows automated and independent removal of empty accumulators/batteries from the vehicle and automated and independent installation of full batteries, but also the issue of the individual accumulators/batteries as a function of time and in an order dependent on different parameters and different selection preferences. The predeterminable order can be determined by the arrival of the electric vehicles at the station.

For example accumulators/batteries can be issued in the order in which they arrive at the accumulator/battery exchange station, i.e. in the order in which the vehicles enter the station and have their accumulators/batteries removed. Such a battery exchange station can, following the same principle as the taxi rank, always take only the standardised accumulators/batteries arranged first in order to make them available to the next vehicle as batteries in fully charged state. A selection of accumulators/batteries as a function of manufacturer is thus not possible.

In such a procedure, the person using the vehicle pays the charging station, by means for example of a payment terminal mounted at the side or similar, a fixed price for the accumulator/battery irrespective of its provenance and/or ownership and also a charging price as a function of the current quantity required to charge the accumulator/battery depending on the momentary charge state of the accumulator/battery removed. In this case the station, which also performs the charging process of the batteries stored and arranged therein, can keep the current-dependent charge price, while in contrast the fixed price for the accumulator/battery is passed on to the retailer or manufacturer of the accumulators/batteries concerned. The remaining residual quantity of energy still present in the accumulator/battery removed can be offset against the energy quantity of the charged accumulators/batteries to be newly installed or used and where applicable flow back into an existing power circuit.

Alternatively the person using the vehicle or a further person in the station may wish to fit a particular accumulator/battery by a particular manufacturer or retailer in his vehicle. This can have the consequence that the order of batteries to be issued in fully charged state can be modified as a function of certain vehicle types to be given priority and a preferred treatment on the basis of a higher charging fee paid. The price for the batteries to be installed is set by the retailer and in this case not influenced by the accumulator/battery exchange station itself but rather passed to the retailer. The station itself in this case earns the costs for the current quantity and for charging the accumulator/battery and the service of the exchange process. Alternatively the station can demand a fixed lump sum price for all batteries issued.

If the accumulator/battery exceeds a predeterminable storage time within the station in which no customer is interested in using it, the station could reduce the fixed price set by the retailer in prespecifiable steps. Also retailers, for batteries which are simultaneously in the possession of the accumulator/battery exchange station performing the charging process, can apply the same accumulator/battery lump sum price for all charging stations.

To avoid preference for its own batteries, the station can give all batteries the same issue price or lease price. Also for example batteries from the company which owns the station can be issued by preference.

Such a network of battery exchange stations means that the long charge times previously required to charge a battery arranged inside an electric vehicle need no longer be spent on the vehicle itself but inside the battery exchange station, while the electric vehicle can be used for continued travel with another battery in full charge state which has been installed in replacement for the empty battery removed. Such an exchange process can for example take 1 to 5 minutes.

The accumulators/batteries in full energy state can be selected from a accumulator/battery stock of the accumulator/battery exchange station by means of a selection device, wherein the selection device performs a data exchange or a unilateral data transmission with a data unit and where applicable with a display unit. The data unit is mounted in or on each accumulator/battery with data on the accumulator/battery owner and/or manufacturer, the charge cycles it has received, its momentary charge state, the charge price and similar data. Such a data unit can be a chip, preferably an RFID chip, which is mounted on the accumulator/battery and which automatically or on request gives the person using the vehicle for example the information on which manufacturer currently has fully charged accumulators/batteries at the station he has selected. Depending on this, the person can decide whether to select another station or another accumulator/battery if the desired accumulator/battery is not in stock. The RFID chip can also be used for further logistics tasks such as for example a regulated payment transaction, the display of service intervals and their performance, and give information on the conservation life of the accumulator/battery.

The accumulators/batteries removed are automatically discharged and/or maintained and/or charged as applicable at the accumulator/battery exchange station.

By the provision of motor vehicles with standardised receiver devices for standardised accumulators/batteries, wherein the motor vehicle can be purchased new without accumulator/battery, advantageously the creation is promoted of a network of charging stations in which such a accumulator/battery exchange takes place preferably automatically, such as for example in the former combustion fuel filling stations. For this according to the invention such accumulator/battery exchange stations have an automatic mechanism with control unit coupled thereto, which when the vehicle enters the station allows automatic removal of the discharged accumulator/battery and reinsertion of a charged accumulator/battery. Advantageously such a accumulator/battery exchange station is equipped with a removal device which detaches a multiplicity of accumulators/batteries, which are standardised in construction at least in groups and in at least partly empty energy state by means of fast fixing connections, from electric vehicles preferably from below, and removes these from the electric vehicles in a prespecified order in order to supply the accumulators/batteries in succession or simultaneously to individual charging stations for charging the energy state of the accumulators/batteries, a storage extraction device for preferably automatic extraction of selectable accumulators/batteries in at least partly full energy state in a predeterminable order, and a loading device for loading the vehicle with accumulators/batteries in preferably full energy state in a selectable order.

Preferably the momentary charge and discharge state of the accumulator/battery is indicated to the driver of the vehicle so that as a function of the momentary charge state of the accumulator/battery he can drive to a correspondingly located station, in the same way as already known with the former motor vehicle engines in combination with the fuel filling stations.

Such an exchange of removable and re-installable accumulators/batteries by means of fast fixing connections in electrically powered motor vehicles allows not only a low cost but also a rapid restoration of the vehicle with the accumulator/battery in the charged state. Also it is not necessary to leave the electrically powered vehicle in the accumulator/battery exchange station provided, which also performs a charging of the accumulators/batteries, because of the automated exchange process. The driver therefore need not—as in refuelling a motor vehicle with conventional combustion engine—leave a warm motor vehicle interior for a possibly cold environment, and there is no risk of inhaling petrol fumes or dirtying hands.

Also such drive-through exchange stations or filling stations could be designed such that payment for the charging process takes place from inside the vehicle, such as for example by automatic detection of the motor vehicle and the type of charging process, by means of transponder technology or by approaching a payment station located at the side of the vehicle and inserting money or credit cards or similar in this payment station.

A comprehensive network of exchange accumulators/batteries also avoids the high procurement price for the electric vehicle with an integral electric accumulator/battery. Rather the vehicle can be sold without accumulator/battery and where applicable without its own charge control unit, which leads to a substantially lower purchase price for electric vehicles.

Such electric vehicles are also environmentally friendly because of the absence of CO2 emissions, powerful, reliable because of the few wearing parts, and can be operated with a low maintenance cost. There is no fine dust pollution from the engine and the noise pollution is reduced.

The accumulator/battery exchange station advantageously has a central control device which determines the predeterminable and selectable order of accumulators/batteries in full energy state as a function of the standardised construction of the accumulators/batteries, their charge state, quality and/or as a function of the activation of failure devices.

A method is shown which allows an extensive supply network of accumulators/batteries in a technical respect, and for accumulator/battery exchange and charging stations, owners of such stations and accumulators/batteries, and keepers of electric vehicles with exchangeable accumulators/batteries, is valuable and financially beneficial as an extensive retail network.

An electric vehicle is shown with a receiver shaft for reception and removal of a accumulator/battery of standardised construction in the receiver shaft which is at least partly standardised in construction. The receiver shaft has standardised terminal connections, dimensions and mechanical fixing devices. The electric vehicle has a transmitter device which, automatically on driving over a certain detection section within the accumulator/battery exchange station or manually, activates the transmission of data to the accumulator/battery exchange station in order to transmit data on the construction of the accumulator/battery, the construction of the vehicle or vehicle type, the charge or discharge state of the accumulator/battery to be exchanged, and similar data. In particular this achieves a registration of the electric vehicle entering the accumulator/battery exchange station in order to register and perform the exchange of the construction-specific accumulator/battery for a accumulator/battery present at least partly in fully charged state. Here individual features of the electric vehicle can also be transferred such as for example particular modifications made to the electric vehicle in relation to the accumulator/battery to be exchanged or the fact that it is an older vehicle which has been later converted for such accumulator/battery exchange.

Because of the fact that the electric vehicle now no longer requires a main charge control unit integrated inside the vehicle but is decoupled from this vehicle, the production costs of the electric vehicle and hence the sale price of the electric vehicle with electric motors can be substantially reduced, the time for supply with newly charged accumulators/batteries for discharged or partially discharged accumulator/battery states can be substantially shortened, and more maintenance-friendly electric vehicles can be made available.

In addition such a method is economically beneficial for investors wishing to invest in an infrastructure for distribution of charged accumulators/batteries. An extensive provision of lease accumulators/batteries available to users of electric vehicles will be ensured. This also creates profitable relationships between the stations owners and the accumulator/battery owners.

Preferably different accumulator/battery manufacturers can be combined in a common system in which again different purchaser groups are equipped with accumulators/batteries which are standardised at least in groups. The accumulators/batteries standardised at least in groups can in turn be accommodated in vehicles of different manufacturers, standardised at least in groups, and for the purpose of rapid energy supply can be exchanged preferably in a few minutes at a accumulator/battery exchange station provided for this. The purchaser groups i.e. the owners, lease accumulators/batteries to the people using the vehicles. The station supplies the accumulators/batteries with energy irrespective of the manufacturer and owner of the accumulators/batteries. The person using the vehicle pays a lump sum for the accumulator/battery which is passed on by the charging station, one to one, to the company owning the accumulator/battery. In addition the person using the vehicle pays the costs of the energy received to the station, which retains this. Differences in vehicle type and size, and energy consumption quantities, can be compensated by different sizes and numbers, standardised at least in groups, of accumulators/batteries used in the vehicle concerned.

The advantages and features are shown in the description below in conjunction with the drawing. These show:

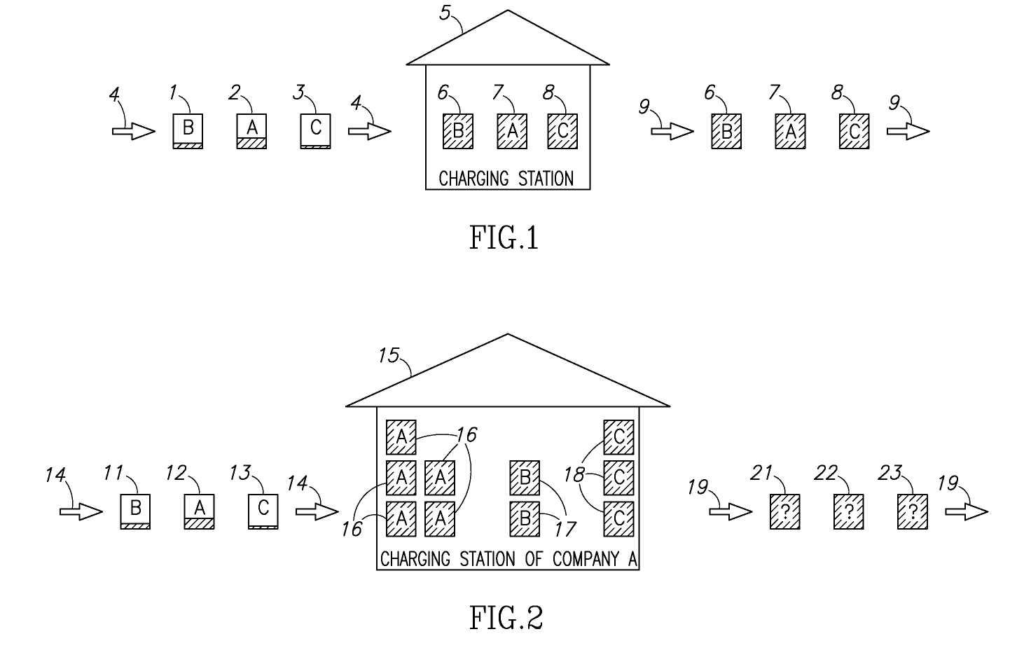

FIG. 1 in a diagrammatic depiction, the method according to the invention in a first embodiment;

FIG. 2 in a diagrammatic depiction, the method according to the invention in a second embodiment;

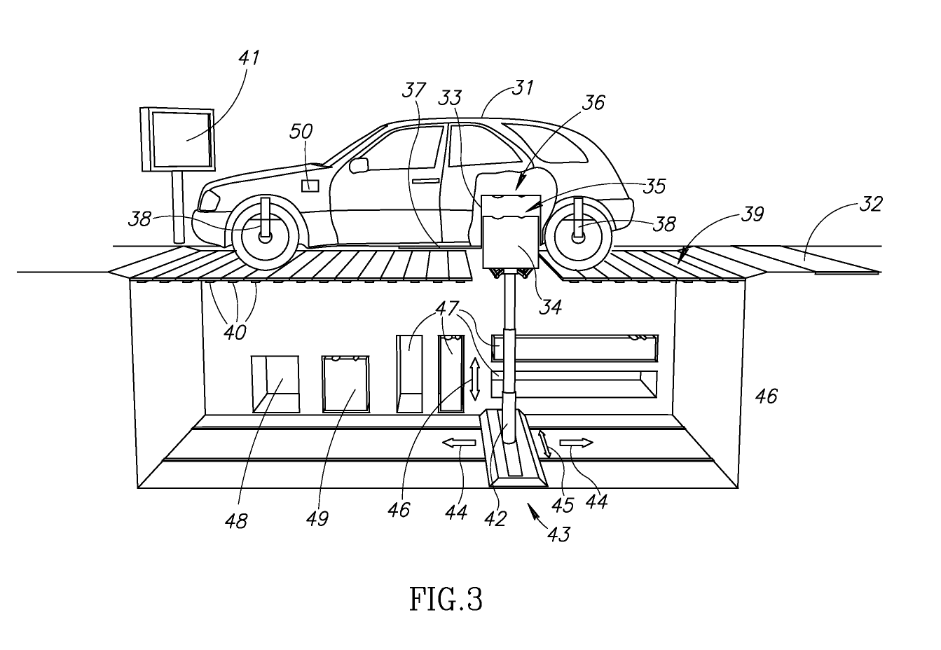

FIG. 3 in a side, partly cross-section view, a device for exchange of a accumulator/battery according to one embodiment of the invention;

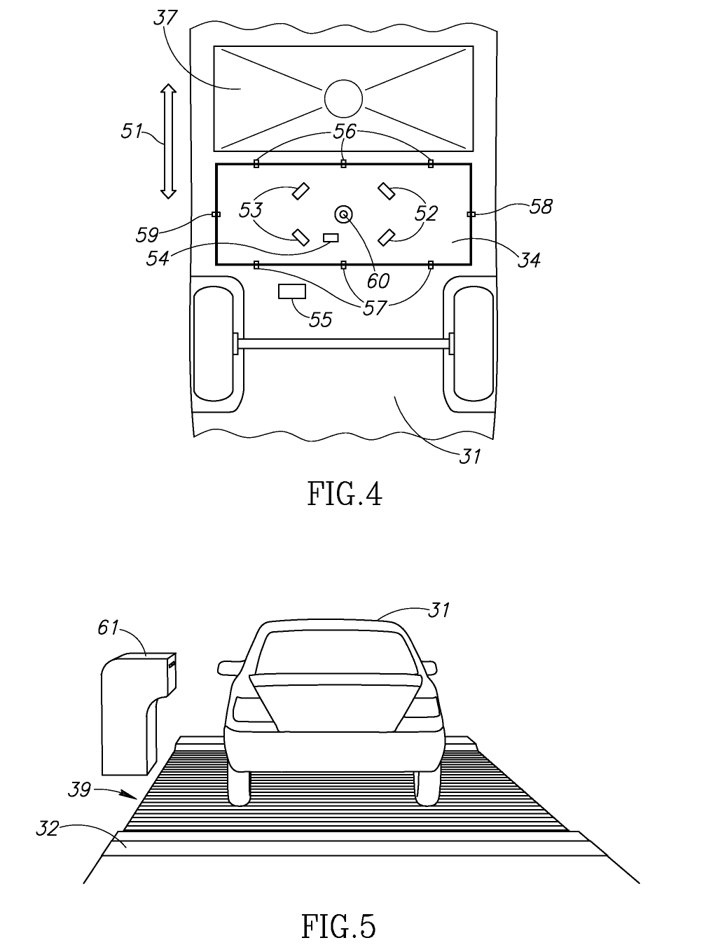

FIG. 4 in an extract view, the underside of the vehicle with a detachable accumulator/battery arranged in this area;

FIG. 5 in a diagrammatic view from the rear, an electric vehicle on a device for exchanging accumulators/batteries;

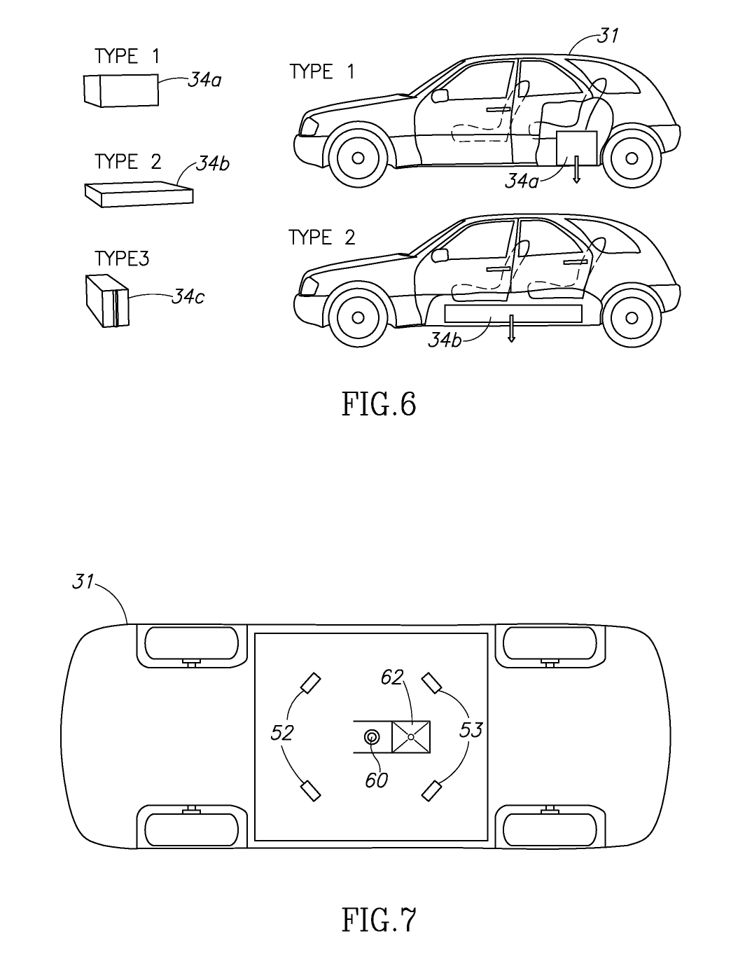

FIG. 6 in a side perspective view, different types of accumulator/battery in removed and fitted state;

FIG. 7 in a view from below, an electric vehicle with accumulator/battery fitted;

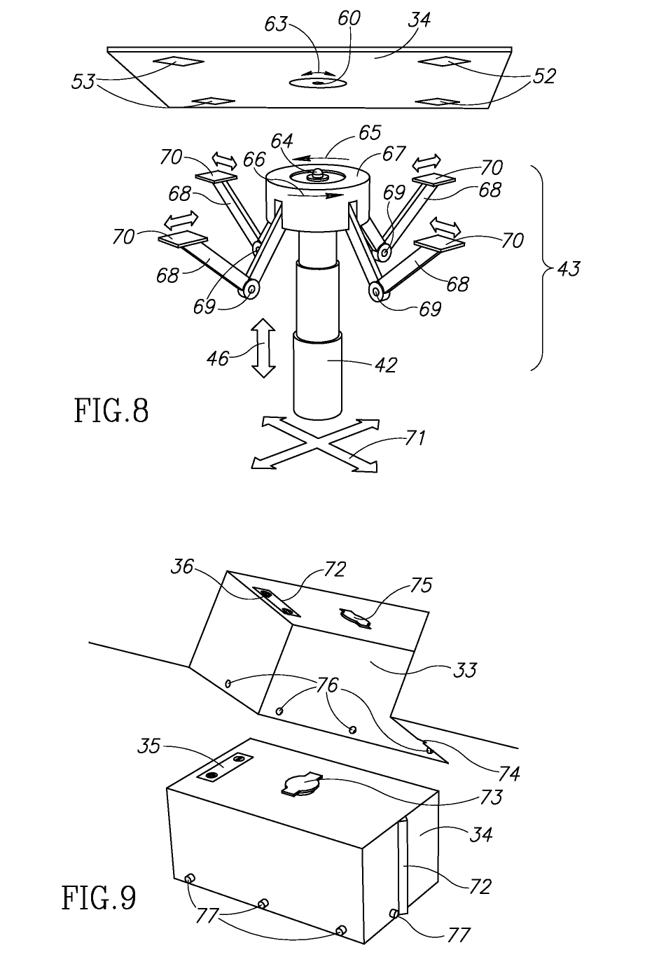

FIG. 8 in a diagrammatic depiction, an extract view of a device for exchange of accumulators/batteries according to one embodiment;

FIG. 9 in an extract view, a accumulator/battery with connections and fixing devices and a complementarily formed receiver recess in the floor area of the electric vehicle;

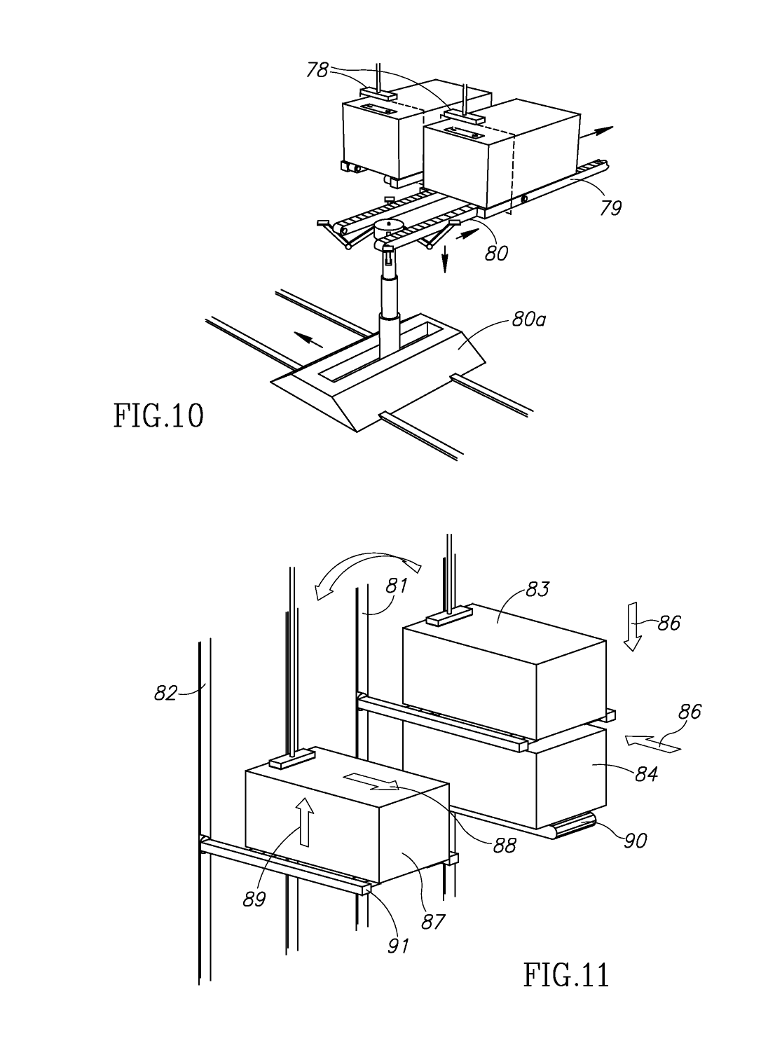

FIG. 10 in a perspective diagrammatic view, a part of the accumulator/battery exchange station, and

FIG. 11 in an extract view, a further part of the accumulator/battery exchange station.

FIG. 1 shows in a diagrammatic depiction the method according to the invention according to a first embodiment. In this depiction the empty accumulators/batteries 1, 2 and 3 received in the accumulator/battery exchange station 5, as depicted by an arrow 4, are arranged in a prespecified order. Within the accumulator/battery exchange station 5 which also serves as a charging station for accumulators/batteries 6, 7 and 8, according to this embodiment of the method according to the invention, each charged accumulator/battery is issued in the same order as an allocated empty accumulator/battery 1, 2, 3 enters the station 5.

Such an issue as indicated by arrow 9 consequently has the same order of accumulators/batteries as the order of empty accumulators/batteries 1, 2, 3 allocated to them. This ensures that a station does not give preference to the accumulators/batteries of a particular company.

FIG. 2 shows a diagrammatic depiction of a second embodiment of the method according to the invention. According to this embodiment in this method the incoming accumulators/batteries 11, 12, 13 which have different charge states are supplied in the accumulator/battery exchange station 15 to a specific company A as indicated by the arrow 14. The company A who is the owner of the station 15 charges and stores amongst others its own accumulators/batteries 16 in fully charged state and further accumulators/batteries 17 and 18, which are also present in fully charged state but do not belong to company A.

Both the persons using the vehicles from which the accumulators/batteries 11, 12, 13 are taken and the operating staff of the station 15 or an automatic control device, as a function of various parameters such as for example the desired preference for certain accumulators/batteries, allow the issue 19 of accumulators/batteries 21, 22, 23 in fully charged state in a particular order. For example the person using the motor vehicle may desire a particular accumulator/battery from company B and this can be given priority preferably as a function of the charging fee to be paid. Alternatively different lump sum prices for different accumulator/battery types can be combined with the same charging fee in one station.

FIG. 3 shows in diagrammatic side view with partial cross section depiction a accumulator/battery exchange station for exchange of accumulators/batteries according to one embodiment of the invention. An electric vehicle 31 is driven onto a base 39 formed as a platform. The platform-like base can be opened at least partly to remove a accumulator/battery 34 which is arranged in a receiver shaft 33 of the motor vehicle 31. This takes place by means of an exchange unit 43, 42 which, as indicated by double arrows 44, 45, 46, can be designed to slide upwards and downwards or to the side.

A detection device 40 below the platform-like base serves to detect the vehicle in its correct position.

The accumulator/battery 34 preferably has at the top locking or fixing retaining elements for mechanical fixing of the accumulator/battery 34 within the receiver shaft 33 and electrical terminal connections 36, 35. Both the mechanical retaining elements and the electrical terminal elements are standardised on all exchangeable accumulators/batteries 47, 48, 34, in this case at the top, in their spacing and shape.

A closing hatch 37 arranged on the floor of the motor vehicle serves to close the receiver shaft 33 again after exchange of the accumulator/battery 34.

Arranged in different recesses or storage shafts 48 of the station, in the lower area below the vehicle, is a multiplicity of different accumulators/batteries 47, 49 which are stored in these recesses and constantly resupplied automatically to fill the recesses.

The shafts 48 are fitted with a receiver strap at the bottom to be described.

The detection device 40 can, as an alternative to a sensor device, carry out an optical and/or acoustic detection of vehicle position from freely selectable locations where it is installed.

The receiver device 42, 43 or exchange unit works automatically i.e. it picks up a suitable accumulator/battery 49 which is present in preferably charged state, after it has automatically removed the discharged accumulator/battery 34 from the receiver shaft 33 of the motor vehicle.

All exchange steps and information relating to payment for the exchange process and the presence of desirable accumulators/batteries are shown to the user on a display device 41.

Fixing devices 38 serve to achieve vertical stabilisation in the area of the vehicle dampers in order to determine and maintain a precise position of the vehicle and receiver shaft 33 during the weight loss occurring when the accumulator/battery is removed. Such a fixing could be activated together with the opening mechanism of the closing hatch 37.

A sensor rail 32 in the ground area serves to detect the vehicle as such and activate the entire accumulator/battery exchange station specifically for this vehicle. As a result for example the vehicle type and hence the accumulator/battery type necessary for exchange are detected.

An additional energy storage unit 50 integrated in the electric vehicle serves to ensure the basic power supply to the vehicle electrics during the exchange process and is recharged during the driving state of the motor vehicle by the exchanged accumulator/battery or by means of energy released from the braking processes and/or solar energy.

FIG. 4 shows in a diagrammatic extract view the underside of a motor vehicle with accumulator/battery installed. The accumulator/battery 34 is arranged inside the receiver shaft 33 which can be closed by means of the closing hatch 37 that can be displaced along the double arrow 51.

After the electric vehicle has been driven onto the platform-like base, when the motor vehicle has stopped the protective cover 37 opens. Throughout the exchange process the motor vehicle is locked directly or indirectly in the area of the dampers and the power supply to the main drive of the motor vehicle is interrupted. This ensures that the motor vehicle cannot be moved undesirably during installation and removal of the accumulator/battery.

The accumulator/battery is detached by the removal device 42, 43 from its centrally arranged fixing retaining element 60 which is formed as a fast fixing element, by for example a twist movement being exerted on the twist lock 60.

In addition locking elements 56, 57, 58 and 59 are fitted on the side along the frame of the receiver shaft 33 to connect the accumulator/battery also to the body of the motor vehicle. This takes place preferably automatically after detection of the installed state of the accumulator/battery.

The removal device has arm-like elements which at their ends engage on receiver elements 53 and 52 of the accumulator/battery.

An integral chip-like data element 55 automatically, for example by means of transponder technology, transmits information to the owner and where applicable about the motor vehicle to the charging station or accumulator/battery exchange station in order to allow cost calculation for example of lease costs per lease cycle, the quantity of former charge cycles and the number of service intervals.

The accumulator/battery 34 is also fitted with a chip unit 54 to communicate with the station and where applicable to communicate with the vehicle-specific on-board instruments.

FIG. 5 shows in a diagrammatic rear view an electric vehicle on the platform-like base. Next to the motor vehicle 31 is arranged a terminal 61 or an operating unit which primarily serves to perform, by means of credit or cheque card, payment for the exchange process and where applicable communication with the service staff. Alternatively or additionally, a vehicle identification card can be inserted manually if a sensor rail 32 arranged in the ground which receives signals when driven over, has incorrectly read information from the chip unit 54.

FIG. 6 shows a multiplicity of possible different accumulators/batteries in fitted and removed state. In total three variants of different standardised accumulator/battery forms are shown. Type 1 according to reference numeral 34a and type 3 according to numeral 34c are upright accumulators/batteries which can be fitted for example behind the rear seats or in the front area. Type 2 according to reference numeral 34b is a accumulator/battery which can be fitted in the floor below the vehicle seat because of its flat design.

FIG. 7 shows from below a motor vehicle with a accumulator/battery in a flat shape on the floor. A floor hatch or closing hatch 37 can be opened to gain access to the central fixing unit 60 for the removal device 42, 43. The accumulator/battery is advantageously attached, by means of a rod-like element extending through the accumulator/battery in the height direction, to the vehicle bodywork at the top and at the bottom has a fixing unit 60 which can be twisted. Furthermore the receiver points 52, 53 for the removal device are shown.

A closing hatch 62 serves to protect the fixing unit 60.

FIG. 8 shows in a diagrammatic perspective depiction an extract of the accumulator/battery exchange station according to one embodiment of the invention. The station has a removal device 42, 43 as it can be constructed for example. It comprises a head unit 67 with a release element 64 arranged centrally thereon, which is introduced in the fixing element 60 with complementarily designed release opening. For this the release element 64 is twisted as indicated by the arrows 65, 66, whereupon the fixing element 60 is also twisted to open as shown by reference numeral 63.

A camera 66 helps ensure that this automatic connection method can be performed with precise fit between the head unit 67 and the accumulator/battery.

Receiver surfaces 70 serve to engage on receiver points 52, 53 of the accumulator/battery. For this arms 68 with joints 69 are arranged, wherein these can be moved in any direction as indicated by the double arrow. Evidently the entire head unit can be rotated about its longitudinal axis and moved up and down, as indicated by the double arrow 46. A translation movement of the head unit and hence the removal device is also possible, as indicated by arrow 71.

When the head unit 67 is attached to the fixing element 66, the release unit 64 is then twisted to open the lock and then by means of the arms 68 attached to the underside of the accumulator/battery, to remove the accumulator/battery by lowering the head unit.

FIG. 9 shows the removed accumulator/battery 34 with an extract from the complementarily shaped receiver shaft 33 inside the vehicle. A central locking disc 73 connected at the bottom with the fixing device 60 has side pegs which can engage in a complementarily formed opening 75 of the receiver shaft when correspondingly twisted, and then by twisting ensure a fixed connection with the receiver shaft.

A standardised terminal connection 35 engages in a complementarily shaped connection unit 36. The element 72 can constitute an additional information connection between the accumulator/battery and vehicle, a mechanical fixing, a cooling system connection control or also a terminal connection. The elements 35, 36 secure an electrical supply of the energy contained in the accumulator/battery to the motor and remaining instruments of the vehicle, whereby a return feed of the energy can also take place via these elements in that energy released for example by means of a braking process can be fed back into the accumulator/battery to charge it.

By means of the twist movement of the centrally arranged release mechanism 60, also side mounted plug pegs 77 can be moved so that they are retracted when the central fixing element 60 of the accumulator/battery is opened. This ensures an additional locking of the accumulator/battery in the fitted state. These plug pegs 77 can engage in correspondingly formed complementary recesses 76.

A guide rail 72 mounted on the side of the accumulator/battery can engage in a complementarily designed guide groove 74 of the receiver shaft 33.

FIG. 10 shows diagrammatically a part of the station. This part has a removal conveyor belt 80 which takes the accumulator/battery in discharged state from the removal device 42, 43 and places it on a conveyor belt 79 which transports the accumulator/battery to a charging station unit. In addition during this process a service unit 78 is transferred from a charged accumulator/battery to a discharged accumulator/battery. This service unit accompanies the discharged accumulator/battery throughout the charge and storage process and serves for its control. It ensures that the accumulator/battery receives the optimum service for its performance and loses no voltage up to the time of its issue.

A guide unit 80a services to move the conveyor belt.

FIG. 11 shows as an extract a further section of the accumulator/battery exchange station according to the invention. A Paternoster system 81, 82 serves to take the discharged accumulator/battery from the conveyor belt 79 and at the same time slide the service unit 78 into a power rail 92. Then the accumulator/battery 87 is stacked on accumulators/batteries previously received 83, 84 for the issue belt 90. The travel directions are indicated by arrows 85, 86, 88 and 89.

The empty accumulator/battery 87 is arranged on a carrier 91.

Within the accumulator/battery exchange station, the removed accumulator/battery is transported to a charging station section and where applicable to a service station extract. Here the accumulator/battery is charged with energy, preferably its function is tested and where applicable it is transferred for service or rejected in the case of malfunction. Also by means of the service unit, first a discharge of the only partly discharged accumulator/battery can take place and then recharging where useful for the life of the accumulator/battery.

Each accumulator/battery can preferably be leased out and paid for per discharge cycle.

Thus a large, preferably extensive energy supply of electrical vehicles is possible in that the accumulators/batteries can be exchanged automatically and quickly in a simple manner at various stations.

All features disclosed in the application documents are claimed as essential to the invention where novel individually or in combination in relation to the prior art.

1. A method for automatically exchanging a depleted energy state accumulator/battery in an electric vehicle at an accumulator/battery exchange station configured for use with a plurality of accumulators/batteries that are substantially standardized in construction comprising:
removing the depleted energy state accumulator/battery from the electric vehicle using a quick release coupler;
exchanging the depleted energy state accumulator/battery for an accumulator/battery in a substantially full energy state; and
installing the substantially full energy state accumulator/battery in the electric vehicle using the quick release coupler;
wherein the order in which the deleted energy state accumulator/battery is exchanged for a substantially full energy state is based on at least one of manual selection, a prespecified order, or instructions from a selector associated with the accumulator/battery exchange station.

2. The method of claim 1, wherein the prespecified order in which accumulators/batteries are exchanged corresponds to the order in which accumulators/batteries are removed from electric vehicles.

3. The method of claim 1, wherein the selector associated with the accumulator/battery, exchange station evaluates characteristic information of the at least one of the accumulator/battery, electric vehicle or an accumulator/battery exchange station storage stock of substantially full energy state accumulators/batteries.

4. The method of claim 3, wherein the characteristic information of the at least one of the accumulator/battery, electric vehicle or an accumulator/battery exchange station storage stock of substantially full energy state accumulators/batteries evaluated by the selector associated with the accumulator/battery exchange station is derived from at least one data unit associated with the accumulator/battery having data of at least one of the holder of the accumulator/battery, the manufacturer of the accumulator/battery, the charge cycles achieved and their number and times for the accumulator/battery, the momentary charge state and charge prices, the momentary location, or service work performed and pending.

5. The method of claim 4, wherein the data unit is formed as a chip.

6. The method of claim 5, wherein the data unit is formed as an RFID chip.

7. An accumulator/battery exchange station for exchange of accumulators/batteries for electric vehicles, comprising:
an accumulator/battery coupler configured to detach depleted energy state accumulators/batteries from and install substantially full energy state accumulators/batteries in electric vehicles using a quick release coupler, wherein the accumulators/batteries have substantially standardized construction;
a charging station configured to charge in succession or simultaneously a plurality of depleted energy state accumulators/batteries; and
an accumulator/battery storage extractor configured to extract substantially full energy state accumulators/batteries based on at least one of manual selection, a prespecified order or instructions from a selector associated with the accumulator/battery exchange station.

8. The accumulator/battery exchange station of claim 7, further comprising a selector configured to evaluate characteristic information of the at least one of the accumulator/battery, electric vehicle or an accumulator/battery charging station stock of substantially full energy state accumulators/batteries.

9. An electric vehicle with an accumulator/battery having substantially standardized construction, the electric vehicle configured to facilitate the exchange of the accumulator/battery when in deleted energy state for a new accumulator/battery in substantially full energy state at an accumulator/battery exchange station, comprising:
a receiver shaft configured to store the accumulator/battery having substantially standardized construction and allow for removal of the accumulator/battery at the accumulator/battery exchange station;
a transmitter associated with the electric car configured to automatically or manually transmit to the accumulator/battery exchange station data on the accumulator/battery construction, such data including at least one of the electric vehicle type, the manufacturer of the accumulator/battery, the momentary charge state of the accumulator/battery, or the charge cycles achieved and their number and times for the accumulator/battery.

10. The electric vehicle of claim 9, wherein the transmitter is configured to transmit accumulator/battery construction data in order to register the electric vehicle for exchange of the accumulator/battery at the accumulator/battery exchange station and activate the exchange process

11. The method of claim 4, wherein the selector is in communication with at least one of the data unit and a display unit in order to obtain or display data related to the characteristic information of the at least one of the accumulator/battery, electric vehicle or accumulator/battery exchange station storage stock.

12. The accumulator/battery exchange station of claim 8, wherein the characteristic information of the at least one of the accumulator/battery, electric vehicle or an accumulator/battery charging station stock of substantially full energy state accumulators/batteries evaluated by the selector is derived from at least one data unit associated with the accumulator/battery having data of at least one of the holder of the accumulator/battery, the manufacturer of the accumulator/battery, the charge cycles achieved and their number and times for the accumulator/battery, the momentary charge state and charge prices, the momentary location, or service work performed and pending.
